(19) United States
(12) Patent Application Publication
(10) Pub. No.: US 2022/0403295 A1
(43) Pub. Date: Dec. 22, 2022

(54) CLEANING COMPOSITIONS AND THEIR USE

(71) Applicant: BASF SE, Ludwigshafen (DE)

(72) Inventor: Stephan HUEFFER, Ludwigshafen (DE)

(73) Assignee: BASF SE, Ludwigshafen (DE)

(21) Appl. No.: 17/776,793

(22) PCT Filed: Nov. 5, 2020
(86) PCT No.: PCT/EP2020/081075

§ 371 Date: May 13, 2022

(30) Foreign Application Priority Data
Nov. 15, 2019 (EP) 19209442.3

(51) Int. Cl. C11D 3/20; C11D 3/33; C11D 3/395; C11D 3/386; C11D 3/37; C11D 11/00

(52) U.S. Cl. CPC C11D 3/2082; C11D 3/2079; C11D 3/33; C11D 3/3953; C11D 3/38618; C11D 3/3765; C11D 11/0023

(57) ABSTRACT

The present invention is directed towards cleaning compositions containing
(A) at least one chelating agent selected from alkali metal salts of methyl glycine diacetic acid (MGDA) and of glutamic acid diacetic acid (GLDA) and of citric acid,
(B) an alkali metal salt of glycine or alanine,
   in a weight ratio of (A):(B) of from 10:1 to 1:10.

The present invention is directed towards cleaning compositions containing
(A) at least one chelating agent selected from alkali metal salts of methyl glycine diacetic acid (MGDA) and of citric acid,
(B) glycine or alanine or an alkali metal or ammonium salt of at least one of the foregoing,

in a weight ratio of (A):(B) of from 10:1 to 1:10.

Modern cleaning compositions need to meet many requirements. They need to work under various conditions, for example various temperatures. They need to yield excellent results, in the case of hard surface cleaners and in particular automatic dishwashing formulations they need to provide excellent results with respect to spotting and filming. In case glass is to be cleaned, glass corrosion needs to be inhibited or at least strongly reduced. Cleaning compositions need to be environmentally friendly, and they have to work even under conditions where only so-called “hard water” is available, for example water with a comparatively high content of Mg²⁺ and Ca²⁺ salts.

In WO 94/29421, chelating agents are disclosed that are environmentally friendly. In EP 0 783 034 A2, it is disclosed that such chelating agents should be used in a form as pure as possible, and high amounts of impurities lead to reduced storage stability.

In WO 2013/165234, it is suggested to replace citric acid by glycine to enhance the stability of a lipase in an automatic dishwashing formulation. In the tests, glycine serves as enzyme stabilizer.

However, in the latter case, cleaning performance still leaves room for improvement.

Furthermore, it has been found that in many cases fatty residues are being accumulated in the fat filter or sieves of automatic dishwashing machines. Such residues usually contain surfactant and fat which has been removed from the dishware, or degradation products from soil. The deposition of residues is disadvantageous because such filters or sieves need cleaning when filled with surfactant and fat. Furthermore, such fatty residues may become smelly in case the machine is not in use for some time, and they may even become a hygiene hazard. Although solutions to this problem have been disclosed, see, e.g., WO 2015/000744 and WO 2017/005793, further solutions are welcome.

It was therefore the objective of the present invention to provide environmentally friendly cleaning compositions with excellent cleaning properties such as spotting and filming. It was further an objective to provide uses for such detergent compositions, and to provide a method for manufacture.

Accordingly, the detergent compositions defined at the outset have been found, hereinafter also referred to as inventive compositions or compositions according to the present invention.

Inventive compositions contain
(A) at least one chelating agent, hereinafter in general referred to as chelating agent (A) or simply (A), wherein chelating agent (A) is selected from alkali metal salts of methyl glycine diacetic acid (MGDA) and of glutamic acid diacetic acid (GLDA) and of citric acid,
(B) glycine or alanine or an alkali metal or ammonium salt of at least one of the foregoing, hereinafter briefly also referred to as (B)—or to glycine (B) or alanine (B), respectively,

in a weight ratio of (A):(B) of from 10:1 to 1:10.

Chelating agent (A) and glycine (B) and alanine (B) will be described in more detail below.

Alkali metal salts may be selected from lithium potassium salts and sodium salts and combinations therefrom. Preferred examples of alkali metal cations are sodium and potassium and combinations of sodium and potassium, and even more preferred in compound according to general formula (I a) and (I b) all M are the same and they are all Na. The same goes for alkali metal salts of citric acid mutatis mutandum.

Preferred chelating agent (A) are selected from the tetrasodium salt of GLDA and the trisodium salt of MGDA and of GLDA and of citric acid and the disodium salt of MGDA and of citric acid and combinations thereof.

For example, the overall formula of

[CH₃—CH(COO)—N(CH₂—COO)₂]M₃₋ₓHₓ (I a)

wherein M is selected from ammonium and alkali metal cations, same or different, for example cations of sodium, potassium, and combinations of the foregoing. Even more preferred in compound according to general formula (I a) all M are the same and they are all Na,

and x in formula (I a) is in the range of from zero to 1.0, preferably 0.015 to 0.5.

In formula (I b)

[OOC—CH₂CH₂—CH(COO)—N(CH₂—COO)₂]M₄₋ₓHₓ (I b)

M is as defined above, and x in formula (I b) is in the range of from zero to 2.0, preferably 0.015 to 1.0. M has been defined above.

MGDA and its respective alkali metal salts are selected from the racemic mixtures, the D-isomers and the L-isomers, and from mixtures of the D- and L-isomers other than the racemic mixtures. Preferably, MGDA and its respective alkali metal salts are selected from the racemic mixture and from mixtures containing in the range of from 55 to 85 mole-% of the L-isomer, the balance being D-isomer. Particularly preferred are mixtures containing in the range of from 60 to 80 mole-% of the L-isomer, the balance being D-isomer. Other particularly preferred embodiments are racemic mixtures.

GLDA and its respective alkali metal salts are selected from the racemic mixtures, the D-isomers and the L-isomers, and from mixtures of the D- and L-isomers other than the racemic mixtures. Preferably, GLDA and its respective alkali metal salts are selected from the racemic mixture and from mixtures containing in the range of from 55 to 99 mole-% of the L-isomer, the balance being D-isomer. Particularly preferred are mixtures containing in the range of from 60 to 98.5 mole-% of the L-isomer, the balance being D-isomer. Other particularly preferred embodiments are racemic mixtures.

In any way, chelating agent (A) may bear a cation other than alkali metal. It is thus possible that minor amounts, such as 0.01 to 5 mol-% of total MGDA, GLDA or citric acid, respectively, bear alkali earth metal cations such as Mg²⁺ or Ca²⁺, or an Fe²⁺ or Fe³⁺ cation.

In one embodiment of the present invention, chelating agent (A) may contain one or more impurities that may result from the synthesis of the respective chelating agent (A). In the cases of MGDA and GLDA, such impurities may be selected from propionic acid, lactic acid, alanine, nitrilotriacetic acid (NTA) or the like and their respective alkali metal salts. In the case of IDS, such impurities may be selected from maleic acid, monoamides of maleic/fumaric acid, and racemic asparagine. Such impurities are usually present in minor amounts. “Minor amounts” in this context refer to a total of 0.1 to 5% by weight, referring to chelating agent (A), preferably up to 2.5% by weight. In the context of the present invention, such minor amounts are neglected when determining the composition of the inventive composition.

Inventive compositions furthermore contain

(B) an amino acid selected from glycine and alanine or an alkali metal or ammonium salt of at least one of the foregoing.

Preferred ammonium salts of alanine (B) and of glycine (B) are selected from C₁-C₄-alkylammonium salts such dimethylammonium, trimethylammonium. ethylammonium, diethylammonium, triethylammonium, and of ω-hydroxy-C2-C4-alkylene ammonium salts such as 2-hydroxyethylammonium, N,N-dihydroxyethylammonium, and N,N,N-trihydroxyethylammonium.

Alanine (B) may be provided as D,L-alanine or as one of the enantiomers, for example as L-alanine or D-alanine, or in enantiomerically enriched form, e.g., as L-alanine: D-alanine in a molar ratio of 3:1 or 10:1.

In one embodiment of the present invention, both (A) and (B) are sodium salts.

The weight ratio of (A) to (B) in inventive compositions is in the range of from 10:1 to 1:10, preferably 5:1 to 1:4. When determining the weight ratio of (A) and (B), in each case the calculation is based on the free acid (zwitterion).

In one embodiment of the present invention, the sum of (A) and (B) constitutes in the range of from 10 to 50% by weight of said composition, referring to the total solids content, preferred are 15 to 35% by weight. The solids content is determined by evaporation in vacuo at 80° C.

At ambient temperature, inventive composition may be liquid, solid or in the form of a paste or a slurry. In a preferred embodiment, inventive compositions are liquid at ambient temperature.

In one embodiment of the present invention, inventive compositions are neutral or alkaline. For example,

Inventive cleaning compositions may contain components other than (A) and (B). It is preferred that inventive composition contain at least one additional component, for example at least one surfactant, at least one bleaching agent, at least one homopolymer of (meth)acrylic acid or a copolymer of acrylic acid with at least one comonomer selected from methacrylic acid, maleic acid, itaconic acid and AMPS, or at least one enzyme, for example a protease or lipase or amylase.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (III)

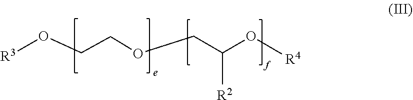

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

The variables e and f are in the range from zero to 300, where the sum of e and f is at least one, preferably in the range of from 3 to 50. Preferably, e is in the range from 1 to 100 and f is in the range from 0 to 30.

In one embodiment, compounds of the general formula (III) may be block copolymers or random copolymers, preference being given to block copolymers.

Other preferred examples of alkoxylated alcohols are, for example, compounds of the general formula (IV)

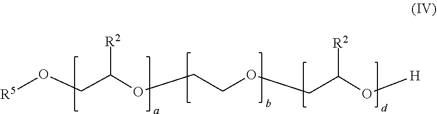

in which the variables are defined as follows:
R² is identical or different and selected from hydrogen and linear C₁-C₄-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Preferred examples for hydroxyalkyl mixed ethers are compounds of the general formula (V)

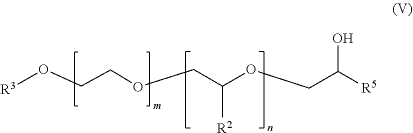

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example iso-C₁₁H₂₃, iso-C₁₃H₂₇, n-C₈H₁₇, n-C₁₀H₂₁, n-C₁₂H₂₅, n-C₁₄H₂₉, n-C₁₆H₃₃ or n-C₁₈H₃₇,
R⁵ is selected from C₆-C₂₀-alkyl, for example n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and n-octadecyl.

The variables m and n are in the range from zero to 300, where the sum of n and m is at least one, preferably in the range of from 5 to 50. Preferably, m is in the range from 1 to 100 and n is in the range from 0 to 30.

Compounds of the general formula (IV) and (V) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (VI) are likewise suitable.

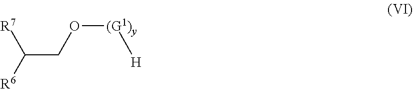

wherein:
R⁶ is C₁-C₄-alkyl, in particular ethyl, n-propyl or isopropyl,
R⁷ is —(CH₂)₂—R⁶,
G¹ is selected from monosaccharides with 4 to 6 carbon atoms, especially from glucose and xylose,
y in the range of from 1.1 to 4, y being an average number,

Further examples of non-ionic surfactants are compounds of general formula (VII) and (VIII)

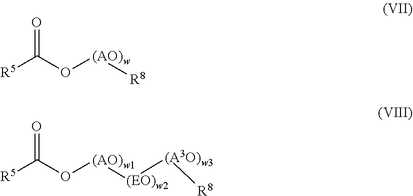

AO is selected from ethylene oxide, propylene oxide and butylene oxide,
EO is ethylene oxide, CH₂CH₂—O,
R⁸ selected from C₈-C₁₈-alkyl, branched or linear, and R⁵ is defined as above.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DE-A 198 19 187.

Mixtures of two or more different nonionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (IX)

R⁹R¹⁰R¹¹N→O (IX)

wherein R⁹, R¹⁰, and R¹¹ are selected independently from each other from aliphatic, cycloaliphatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁰ and R¹¹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Examples of suitable anionic surfactants are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Further examples for suitable anionic surfactants are soaps, for example the sodium or potassium salts of stearic acid, oleic acid, palmitic acid, ether carboxylates, and alkylether phosphates.

In one embodiment of the present invention, inventive compositions may contain 0.1 to 60% by weight of at least one surfactant, selected from anionic surfactants, amphoteric surfactants and amine oxide surfactants.

In a preferred embodiment, inventive compositions contain at least one anionic surfactant.

Inventive compositions may contain at least one bleaching agent, also referred to as bleach. Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate. Inventive compositions that are liquid preferably do not contain both bleaching agent and enzyme.

Examples of organic peroxide bleaches are organic percarboxylic acids, especially organic percarboxylic acids.

In inventive compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive compositions may comprise, for example, in the range from 3 to 10% by weight of chlorine-containing bleach.

Inventive compositions may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive compositions may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

Inventive compositions may comprise one or more corrosion inhibitors. In the present case, this is to be understood as including those compounds that inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, inventive compositions comprise in total in the range from 0.1 to 1.5% by weight of corrosion inhibitor.

Inventive compositions may comprise one or more builders, selected from organic and inorganic builders. Examples of suitable inorganic builders are sodium sulfate or sodium carbonate or silicates, in particular sodium disilicate and sodium metasilicate, zeolites, sheet silicates, in particular those of the formula α-Na₂Si₂O₅, β-Na₂Si₂O₅, and δ-Na₂Si₂O₅, also fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

Examples of organic builders are especially
(C) homopolymers of (meth)acrylic acid or a copolymer of acrylic acid with at least one comonomer selected from methacrylic acid, maleic acid, itaconic acid and AMPS, hereinafter jointly also referred to as (co)polymers (C) and separately as polymers (C) and copolymers (C), respectively, in each case as free acids or partially or fully neutralized with alkali metal, especially with sodium.

In one embodiment of the present invention, organic builders are selected from polycarboxylates, for example alkali metal salts of (meth)acrylic acid homopolymers or (meth)acrylic acid copolymers.

Examples of suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M_{w} in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropane-1-sulfonic acid (AMPS), 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of organic builders is carboxymethyl inulin.

Moreover, amphoteric polymers can also be used as builders.

Inventive compositions may comprise, for example, in the range from in total 10 to 70% by weight, preferably up to 50% by weight, of builder. In the context of the present invention, chelating agent (A) is not counted as builder.

In one embodiment of the present invention, inventive compositions may comprise one or more co-builders.

Inventive compositions may comprise one or more antifoams, selected for example from silicone oils and paraffin oils.

In one embodiment of the present invention, inventive compositions comprise in total in the range from 0.05 to 0.5% by weight of antifoam.

Inventive compositions may comprise one or more enzymes. Examples of enzymes are lipases, hydrolases, amylases, proteases, cellulases, esterases, pectinases, lactases and peroxidases.

In one embodiment of the present invention, inventive compositions may comprise, for example, up to 5% by weight of enzyme, preference being given to 0.1 to 3% by weight. Said enzyme may be stabilized, for example with the sodium salt of at least one C₁-C₃-carboxylic acid or C₄-C₁₀-dicarboxylic acid. Preferred are formates, acetates, adipates, and succinates.

In one embodiment of the present invention, inventive compositions, especially when used as automatic dishwashing detergents, may comprise at least one zinc salt. Zinc salts may be selected from water-soluble and water-insoluble zinc salts. In this connection, within the context of the present invention, water-insoluble is used to refer to those zinc salts which, in distilled water at 25° C., have a solubility of 0.1 g/l or less. Zinc salts which have a higher solubility in water are accordingly referred to within the context of the present invention as water-soluble zinc salts.

In one embodiment of the present invention, zinc salt is selected from zinc benzoate, zinc gluconate, zinc lactate, zinc formate, ZnCl₂, ZnSO₄, zinc acetate, zinc citrate, Zn(NO₃)₂, Zn(CH₃SO₃)₂ and zinc gallate, preferably ZnCl₂, ZnSO₄, zinc acetate, zinc citrate, Zn(NO₃)₂, Zn(CH₃SO₃)₂ and zinc gallate.

In another embodiment of the present invention, zinc salt is selected from ZnO, ZnO.aq, Zn(OH)₂ and ZnCO₃. Preference is given to ZnO.aq.

In one embodiment of the present invention, zinc salt is selected from zinc oxides with an average particle diameter (weight-average) in the range from 10 nm to 100 μm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH of mixture according to the invention is adjusted, zinc salt can change. Thus, it is for example possible to use zinc acetate or ZnCl₂ for preparing formulation according to the invention, but this converts at a pH of 8 or 9 in an aqueous environment to ZnO, Zn(OH)₂ or ZnO.aq, which can be present in non-complexed or in complexed form.

Zinc salt may be present in those inventive automatic dishwashing formulations which are solid at room temperature are preferably present in the form of particles which have for example an average diameter (number-average) in the range from 10 nm to 100 μm, preferably 100 nm to 5 μm, determined for example by X-ray scattering.

Zinc salt may be present in those detergent compositions for home care applications that are liquid at room temperature in dissolved or in solid or in colloidal form.

In one embodiment of the present invention, inventive automatic dishwashing formulations comprise in total in the range from 0.05 to 0.4% by weight of zinc salt, based in each case on the solids content of the composition in question.

Here, the fraction of zinc salt is given as zinc or zinc ions. From this, it is possible to calculate the counterion fraction.

In one embodiment of the present invention, inventive automatic dishwashing formulation contain polyalkylenimine, for example polypropylenimine or polyethylenimine. Polyalkylenimine may be substituted, for example with CH₂COOH groups or with polyalkylenoxide chains, or non-substituted. In one embodiment of the present invention, 60 to 80 mole-% of the primary and secondary amine functions of polyalkylenimines are substituted with CH₂COOH groups or with ethylene oxide or propylene oxide. Particularly preferred are non-substituted polyethylenimine with an average molecular weight M_{w} in a range of from 500 to 20,000 g/mol, determined advantageously by gel permeation chromatography (GPC) in 1.5% by weight aqueous formic acid as eluent and cross-linked poly-hydroxyethylmethacrylate as stationary phase. In other embodiments, polyethoxylated polyethylenimines are preferred, with an average molecular weight M_{w} in a range of from 2,500 to 50,000 g/mol, determined advantageously by gel permeation chromatography (GPC) in 1.5% by weight aqueous formic acid as eluent and cross-linked polyhydroxyethylmethacrylate as stationary phase. In other embodiments, polyethoxylated polypropylenimines are preferred, with an average molecular weight M_{w} in a range of from 2,500 to 50,000 g/mol, determined advantageously by gel permeation chromatography (GPC) in 1.5% by weight aqueous formic acid as eluent and cross-linked poly-hydroxyethylmethacrylate as stationary phase.

Polyethylenimines and polypropylenimines, non-substituted or substituted as above, may applied in small amounts, for example 0.01 to 2% by weight, referring to the total solids content of the respective inventive automatic dishwashing formulation.

In one embodiment of the present invention, inventive compositions are free from heavy metals apart from zinc compounds. Within the context of the present, this may be understood as meaning that inventive compositions are free from those heavy metal compounds which do not act as bleach catalysts, in particular of compounds of iron and of bismuth. Within the context of the present invention, “free from” in connection with heavy metal compounds is to be understood as meaning that the content of heavy metal compounds that do not act as bleach catalysts is in sum in the range from 0 to 100 ppm, determined by the leach method and based on the solids content. Preferably, detergent compositions according to the invention has, apart from zinc, a heavy metal content below 0.05 ppm, based on the solids content of the formulation in question. The fraction of zinc is thus not included.

Within the context of the present invention, “heavy metals” are defined to be any metal with a specific density of at least 6 g/cm³ with the exception of zinc. In particular, the heavy metals are metals such as bismuth, iron, copper, lead, tin, nickel, cadmium and chromium.

Preferably, inventive automatic dishwashing formulations comprise no measurable fractions of bismuth compounds, i.e. for example less than 1 ppm.

In one embodiment of the present invention, inventive compositions comprise one or more further ingredient such as fragrances, dyestuffs, organic solvents, buffers, disintegrants for tabs, and/or acids such as methylsulfonic acid.

Inventive compositions are excellently suited for various cleaners, e.g., in hard surface cleaning such as, but not limited to automatic dishwashing, and in laundry. They are excellently suited for environmentally friendly cleaning compositions and provide excellent cleaning properties such as spotting and filming even when hard water is used.

Another aspect of the present invention is a process for cleaning laundry or hard surfaces, e.g., dishware, preferably in an automatic dishwasher, hereinafter also referred to as inventive cleaning process. The inventive cleaning process is characterized in that it is performed under use of an inventive composition.

The term “hard surface cleaners” includes compositions for dishwashing, especially hand dish-wash and automatic dishwashing and ware-washing, and compositions for other hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, but not laundry detergent compositions.

Dishware as used hereunder includes china, polymer, metal, clay, and glassware. A process to clean dishware includes removal of all sorts of soil, like fat, proteins, starch, dyes, and more.

More specifically, the term “dishware” includes articles used in the preparation, serving, consumption, and disposal of food stuffs including pots, pans, trays, pitchers, bowls, plates, saucers, cups, glasses, forks, knives, spoons, spatulas, and other glass, metal, ceramic, plastic composite articles commonly available in the institutional or household kitchen or dining room. In general, such dishware can be referred to as food or beverage contacting articles because they have surfaces which are provided for contacting food and/or beverage. When used in these ware-washing applications, cleaning composition and/or rinse aid should provide effective sheeting action and low foaming properties. In addition to having the desirable properties described above, it may also be useful for cleaning compositions and/or rinse aids to be biodegradable, environmentally friendly, and generally nontoxic. A cleaning composition and/or rinse aid of this type may be described as being “food grade”.

The inventive cleaning process is being carried out at temperatures in the range of from 10 to 90° C. In embodiments wherein the inventive cleaning process is carried out as an automatic dishwashing process, it is preferably carried out at a temperature in the range of from 45 to 65° C., more preferably 50 to 60° C. Said temperature refers to the temperature of the water being used in the inventive process.

The inventive process is being carried out using water. In embodiments wherein the inventive cleaning process is carried out as an automatic dishwashing process, the amount of water is influenced by the type of machine used and by the choice of the program.

The water used may have a German hardness in the range of from zero to 25° dH, referring to the permanent hardness.

In embodiments wherein the inventive cleaning process is carried out as an automatic dishwashing process, the inventive cleaning process is preferably performed with a combination of two compositions of which one is an inventive composition, and the other composition comprises at least one non-ionic surfactant and at least one inorganic salt selected from alkali metal sulfates and alkali metal (bi)carbonates.

The present invention is further illustrated by working examples.

### Static CaCO₃ Bottle/Scaling Test Method

The static bottle tests were carried out at 50° C. The test bottle was charged with 50 ml calcium hydrogen carbonate solution formed in situ from combining calcium brine with aqueous hydrogen carbonate solution and that corresponds to ca 25° dH or ca. 450 ppm Ca. Then dosage with a pre-calculated amount of inventive formulation or comparative formulations (Table 1), respectively, and adjustment of pH to 9.9-10.1, followed by a visual check. After placing the test bottles into a preheated water bath at 50° C., test bottles were visually examined for precipitates/clouding and the time was recorded when clouding/precipitations were observed.

TABLE 1
static CaCO₃ scale inhibition

| Run | Builder [ppm] | t = 0 | t = 30 min | t = 1 h | t = 90 min | t = 2 h | t = 2.5 h |
|---|---|---|---|---|---|---|---|
| Comp. 1 | (A.1) 1000 | ++ | ++ | ++ | + | + | + |
| Comp. 2 | (A.1): 550 | ++ | ++ | + | 0 | 0 | 0 |
| Comp. 3 | (A.2): 1000 | ++ | ++ | ++ | + | 0 | 0 |
| Comp. 4 | (A.2): 700 | ++ | ++ | + | 0 | − | − |
| Comp. 5 | (A.3): 1500 | ++ | + | − | − | −− | −− |
| Comp. 6 | (A.3): 1500; (C.1): 300 | ++ | + | + | 0 | − | − |
| Comp. 7 | (A.3): 1500; (C.2): 250 | ++ | ++ | + | + | 0 | − |
| Comp. 8 | (A.3): 1500; (C.3): 250 | ++ | ++ | + | + | 0 | 0 |
| Comp. 9 | (A.3): 1500, (C.2): 250, | ++ | ++ | + | + | 0 | 0 |
| | HEDP: 100 | | | | | | |
| 10 | (A.3): 1000, (B.1): 400 | ++ | ++ | + | + | + | + |
| 11 | (A.3): 1000, (B.1): 300 | ++ | ++ | + | + | + | 0 |
| 12 | (A.3): 1000, (B.1): 150; | ++ | ++ | + | + | + | + |
| | (C.2): 40 | | | | | | |
| 13 | (A.3): 1100 + (B.1): | ++ | ++ | + | + | + | + |
| | 150; (C.3): 40 | | | | | | |
| 14 | (A.3): 1100 (B.2): 150; | ++ | ++ | + | + | 0 | 0 |
| | (C.3): 40 | | | | | | |
| 15 | (A.2): 700; (B.1): 200 | ++ | ++ | ++ | + | + | + |
| 16 | (A.2): 700; (B.2): 200 | ++ | ++ | + | + | + | 0 |
| 17 | (A.2): 700; (B.1): 200; | ++ | ++ | ++ | ++ | + | + |
| | (C.2): 30 | | | | | | |
| 18 | (A.1): 450 + (B:1): 200; | ++ | ++ | ++ | + | + | + |
| | (C.2): 30 | | | | | | |

Similar results are obtained when (C.2) is replaced by (C.3).
Abbreviations:
(A.1): MGDA-Na₃
(A.2): GLDA-Na₄
(A.3): trisodium citrate
(B.1): sodium salt of glycine
(B.2): sodium salt of L-alanine
(C.1): polyacrylic acid, 25 mol-% neutralized with sodium hydroxide, M_{w}: 4,000 g/mol, determined by GPC and referring to the free acid
(C.2): copolymer 85% by weight acrylic acid, 15% by weight 2-acrylamido-2-methylpropane-1-sulfonic acid (AMPS), fully neutralized with NaOH, M_{w} 8,000 g/mol,
(C.3): copolymer itaconic acid/acrylic acid/AMPS 6:3:1 by weight, M_{w} 6,500 g/mol
HEDP: 1,1-1-hydroxyethyldiphosphonic acid

Said measurements were performed at a pH value of 7.4 (phosphate buffer), stationary phase: cross-linked polyacrylate, mobile phase: water, pH value 7.4, phosphate buffer with 0.01 M NaN₃.

The compositions according to Table 2 were used for making detergent compositions according to the invention and comparison detergent compositions.

TABLE 2
Compositions

| component | C-Comp-1 | C-Comp-2 | Comp-3 | Comp-4 |
|---|---|---|---|---|
| Protease | 2.0 | 2.0 | 2.0 | 20 |
| Amylase | 1 | 1 | 1 | 1 |
| n-C₁₂-alkyl polyglucoside | 1 | 1 | 1 | 1 |
| Mixed hydroxy ether/polymer | 4 | 4 | 4 | 4 |
| (C.2) | 4 | 4 | 1.5 | 1.5 |
| Sodium percarbonate | 10.0 | 8.0 | 10.0 | 10.0 |
| TAED | 4 | 4 | 3 | 3 |
| Na₂Si₂O₅, commercial | 2 | 2 | 3 | 3 |
| product (Britesil ®) | | | | |
| Na₂CO₃ | 24 | 22 | 25 | 22 |
| (A.1) | 10 | 30 | 10 | 10 |
| (B.2) | — | — | 15 | — |
| (B.1) | | | | 10 |
| (A.3) | 30 | 15 | 15 | 20 |
| HEDP | 2.0 | 1.0 | — | — |

Na₂SO₄ to 100%
All data in g.

“Mixed hydroxy ether/polymer”: 4:1 by weight mix of graft copolymer A.10 from WO 2019/197315 and n-C₁₀H₂₁—CH(OH)—CH₂—O-(EO)₄₀-n-C₁₀H₂₁

Firstly, base mixtures were prepared from the feed materials according to Table 2. The feed materials as well as the respective complexing agent (A) were mixed in dry state apart from (T2), which was finally added in molten form.

General Remarks about the Dish-Wash Process:

### Spotting, Filming, Fat Residue and Odor Tests:

All dish-wash experiments were carried out in Miele automatic dish wash machines, type G1222 SCL. The program 40° C. (“R-time 2”, for washing) and 55° for rinsing was selected. No separate rinsing agent was added, no regenerating salt was used. Before the tests started the sieves of the dishwashers were weighed. The dish-wash experiments were carried out with water, 21° dH (German hardness), Ca/Mg:HCO₃ (3:1):1.35. In each experiment three knives (stainless steel), three blue melamine resin plates, eleven drinking glasses and fourteen plates from china were placed in the dishwasher. Before each cycle, 5 g of Biskin Gold®, a solid vegetable fat, and 5 g of margarine and 50 g additional ballast soil (RA mix) were added. In each cycle of an experiment according to the invention, 18 g of a detergent composition according to table 3 were added.

5 cycles were run without drying times between cycles. After the 5^{th} cycle odor was noted by three test persons and the sieve was taken out of the machine for inspection and evaluation—then again put into the machine which was closed and stored for another 48 hours at 25° C. Then weights of the sieves (fat) were determined and the differences to their weights before the first cycle were calculated. Finally, visual assessment with respect to filming and soiling were executed on porcelain, glass, cutlery and plastic individually and on the average. The visual assessment was made according to the following table rank:
7 points: excellent; without any marks, no filming
5-6 points: good, 1 to 4 spots almost invisible filming
2-4 points: fair, more than 4 spots to 25% of the surface covered with stains, moderate filming
1 point: 25 to 50% of the surface covered with stains
0 points: almost completely covered with spots, significant filming

In table 3, only the average values are shown (values with number round and 0.5 as possible fine scale).

Odor is ranked in 4 grades: from 4=neutral, no odor, to 1=significant malodor (fool, fishy); value is average of 3 evaluators

The results are summarized in Table 4.

The odor was determined after 48 hours storage at 25° C. after the 5^{th} cycle.

TABLE 3
Automatic dishwashing tests

| | | | Fat in | Odor | Odor |
|---|---|---|---|---|---|
| | Spots | Filming | sieve | Average | (48 h, 25° C.) |
| Feed material | Average | Average | [g] | 20 min. | After 5^{th} cycle |
| C-Comp. 1, | 4.6 | 4.3 | 3.4 | 2.5 | 1 |
| run 1 | | | | | |
| C-Comp. 1, | 4.9 | 4.4 | 4.1 | 2.5 | 1 |
| run 2 | | | | | |
| C-Comp. 2, | 5.2 | 4.5 | 2.8 | 2.0 | 1.5 |
| run 1 | | | | | |
| C-Comp. 2, | 5.3 | 4.8 | 2.5 | 2.0 | 1.5 |
| run 2 | | | | | |
| Comp. 3, | 5.7 | 5.4 | 2.4 | 3.5 | 3 |
| run 1 | | | | | |
| Comp. 3, | 6.0 | 5.2 | 2.3 | 3 | 3 |
| run 2 | | | | | |
| Comp. 4, | 5.9 | 6.7 | 2.1 | 3.5 | 3 |
| run 1 | | | | | |
| Comp. 4, | 6.2 | 6.0 | 2.0 | 4 | 3.5 |
| run 2 | | | | | |

1. A cleaning composition, comprising
(A) at least one chelating agent selected from alkali metal salts of methyl glycine diacetic acid (MGDA) and of glutamic acid diacetic acid (GLDA) and of citric acid, and
(B) glycine or alanine or an alkali metal or ammonium salt of at least one of the foregoing, in a weight ratio of (A):(B) of from 10:1 to 1:10.

2. The composition according to claim 1, wherein chelating agent (A) is selected from the tetrasodium salt of GLDA and the trisodium salt of MGDA and of GLDA and of citric acid and the disodium salt of MGDA and of citric acid and combinations thereof.

3. The composition according to claim 1, wherein both (A) and (B) are sodium salts.

4. The composition according to claim 1, wherein MGDA is provided as mixture of enantiomers, said mixture containing predominantly the respective L-enantiomer with an enantiomeric excess (ee) in the range of from 10 to 75%.

5. The composition according to claim 1, wherein alanine (B) is L-alanine.

6. The composition according to claim 1, wherein said composition further comprises a surfactant.

7. The composition according to claim 1, wherein said composition further comprises a bleaching agent.

8. The composition according to claim 1, wherein said composition further comprises
(C) a homopolymer of (meth)acrylic acid or a copolymer of acrylic acid with at least one comonomer selected from methacrylic acid, maleic acid, itaconic acid and AMPS.

9. The composition according to claim 1, wherein said composition is liquid at ambient temperature.

10. The composition according to claim 1, wherein said composition further comprises a protease.

11. The composition according to claim 1, wherein the sum of (A) and (B) constitutes in the range of from 10 to 50% by weight of said composition, referring to the total solids content.

12. A process for cleaning dishware in an automatic dishwasher, comprising adding a composition according to claim 1 to an automatic dishwasher comprising dishware.

13. A process for cleaning dishware in an automatic dishwasher, comprising adding a combination of two compositions of which one is a composition according to claim 1, and the other composition comprises at least one non-ionic surfactant and at least one inorganic salt selected from alkali metal sulfates and alkali metal (bi)carbonates, to an automatic dishwasher comprising dishware.
